(19) United States
(12) Patent Application Publication
(10) Pub. No.: US 2010/0014969 A1
(43) Pub. Date: Jan. 21, 2010

(54) WIND TURBINE WITH BLADE PITCH CONTROL TO COMPENSATE FOR WIND SHEAR AND WIND MISALIGNMENT

(76) Inventors: Kitchener Clark Wilson, Santa Barbara, CA (US); William Erdmann, Moraga, CA (US); Timothy J. McCoy, Seattle, WA (US)

Correspondence Address: FAY SHARPE LLP, 1228 Euclid Avenue, 5th Floor, The Halle Building, Cleveland, OH, 44115, US

(21) Appl. No.: 12/443,916

(22) PCT Filed: Mar. 15, 2007
(86) PCT No.: PCT/IB07/00648

§ 371 Date: Sep. 29, 2009

Related U.S. Application Data
(60) Provisional application No. 60/849,160, filed on Oct. 2, 2006.

(51) Int. Cl. F03D 7/00

(52) U.S. Cl. 416/1; 416/31

(57) ABSTRACT

A wind turbine or rotor load control compensates for moment imbalance in a wind turbine that includes a rotor having at least two variable pitch blades. The apparatus includes a conventional pitch command logic developing a nominal rotor blade pitch command signal and a moment sensor. The moment sensor can be one or more of a nacelle overturning moment sensor, and a turning moment sensor. An output of this is used as a moment signal. Conversion logic is connected to the moment signal with an output of the conversion logic being calculated individual pitch modulation commands for each of the blades. A combining logic is connected to receive the calculated individual blade pitch modulation commands and to receive a nominal pitch command. An output of the combining logic is individual combined blade pitch commands for each of the blades. The individual combined blade pitch commands are generated by modulating the nominal command signal by a respective blade pitch modulation command which includes compensation for instantaneous moment deviations of the wind turbine.

### FIELD OF THE INVENTION

The invention relates to fluid-flow turbines, such as wind turbines and more particularly to an apparatus and method to compensate for wind shear and wind misalignment.

### DESCRIPTION OF THE PRIOR ART

The development of practical, wind-powered generating systems creates problems, which are unique and not encountered in the development of conventional power generating systems. The natural variability of the wind affects the nature and quality of the electricity produced. The relationship between the velocity of the tip of a turbine blade and the wind velocity affects the maximum energy that may be captured from the wind. These issues together with mechanical fatigue due to wind variability have a significant impact on the cost of wind-generated electricity.

In the past, wind turbines have been operated at constant speed. The torque produced by the blades and main shaft determines the power delivered by such a wind turbine. The turbine is typically controlled by a power command signal, which is fed to a turbine blade pitch angle servo. This servo controls the pitch of the rotor blades and therefore the power output of the wind turbine. Because of stability considerations, this control loop must be operated with a limited bandwidth and, thus is not capable of responding adequately to wind gusts. In this condition, main-shaft torque goes up and transient power surges occur. These power surges not only affect the quality of the electrical power produced, but they create significant mechanical loads on the wind turbine itself. These mechanical loads further force the capital cost of turbines up because the turbine structures must be designed to withstand these loads over long periods of time, in some cases 20 30 years.

To alleviate the problems of power surges and mechanical loads with constant speed wind turbines, the wind power industry has been moving towards the use of variable speed wind turbines. A variable speed wind turbine is described in U.S. Pat. No. 7,042,110.

Large modern wind turbines have rotor diameters of up to 100 meters with towers in a height to accommodate them. In the US tall towers are being considered for some places, such as the American Great Plains, to take advantage of estimates that doubling tower height will increase the wind power available by 45%.

To simplify this discussion, wind shear is used generally to include the conventional vertical and horizontal shears as well as the effect of wind misalignment (e.g. due to yaw misalignment).

Studies have shown that wind shear varies over the height and breadth of large horizontal-axis wind turbines. Wind shear is likely to be more pronounced in the case of tall towers. Wind shear is a change in wind direction and speed between different vertical or horizontal locations. Wind turbine fatigue life and power quality are affected by loads on the blades caused by wind shear fluctuations over the disk of rotation of the blades.

Loading across these rotors may vary because of differences in wind speed between the highest point of the rotor, with gradually less wind speed towards the lowest point of the rotor, and the least wind speed at the lowest point of the rotor. It also varies horizontally across the rotor. Thus, at any point in time, each blade may have a different load due to wind depending upon its real-time rotational position. These loads contribute to fatigue on the rotor blades and other wind turbine components.

Various techniques are in use, or proposed for use, to control a wind turbine. The goal of these control methodologies is to maximize electrical power generation while minimizing the mechanical loads imposed on the various turbine components. Loads cause stress and strain and are the source of fatigue failures that shorten the lifespan of components. Reducing loads allows the use of lighter or smaller components, an important consideration given the increasing sizes of wind turbines. Reducing loads also allows the use of the same components in higher power turbines to handle the increased wind energy or allows an increase in rotor diameter for the same rated power.

Wind shear is a largely deterministic disturbance having a slowly varying mean component although instantaneously wind shear varies due to turbulence. Turbine control systems can account for the mean component in order to reduce loads, reduce motor torque, and provide better control. Control systems range from the relatively simple proportional, integral derivative (PID) collective blade controllers to independent blade state space controllers. Whatever the type of control, the more that deterministic disturbances are included or compensated for, the better the control mechanization, because less is attributed to stochastic disturbances.

Whatever their sources, wind shear causes a turbine moment imbalance that tends to rotate the turbine or bend the blades. Accordingly, it is desirable to provide load or moment imbalance compensation as a component of a turbine control system, wherein the moment imbalance is due to wind shear or other sources.

It is also desirable to provide a wind turbine in which loads caused by wind shear moment imbalances are mitigated.

### SUMMARY OF THE INVENTION

Briefly, the present invention relates to an apparatus and method of controlling a wind turbine having a number of rotor blades comprising a method of moment imbalance compensation. The moment imbalance may be caused by vertical wind shear, horizontal wind shear, wind misalignment, yaw error, or other sources. The wind turbine uses a pitch command to control pitch of the rotor blades of the wind turbine. The control first determines and stores a relationship between various values of instantaneous moment and a pitch modulation that compensates for deviations of the instantaneous moment from a nominal moment value. The control senses an instantaneous moment of the wind turbine resulting in a moment signal. The control uses the moment signal to calculate a blade pitch modulation needed to compensate for the instantaneous moment imbalance. The calculated blade pitch modulation is combined with the nominal pitch command determined to control, for example, the rotor rpm. Finally the combination is used to control pitch of the rotor blades in order to compensate for the instantaneous moment deviations of the wind turbine.

The invention therefore uses output of conventional control systems and adds compensation for instantaneous conditions deviating from nominal or mean conditions by modulation of the control signals. Since conventional control systems are rather based on mean values they do not take instantaneous changes into account. By modulating signals of the slowly reacting control systems compensation for instantaneous or short-time disturbances is achieved. However the basic control mechanism providing the basic pitch command is not affected since only the output signal is modulated. Therefore the system can smoothly and stably return to the unmodulated control values if deviations of the nominal values are not registered.

The invention therefore also uses control systems that inherently formulate compensation for instantaneous conditions deviating from nominal or mean conditions by simultaneously determining the collective and the individual blade commands while directly using the turbine measurements. Such control systems are referred to as state space designs.

In accordance with an aspect of the invention the source of the moment imbalance is one or more of vertical wind shear, horizontal wind shear, and wind misalignment in the horizontal and/or vertical plane.

### BRIEF DESCRIPTION OF THE DRAWINGS

The invention and its mode of operation will be more fully understood from the following detailed description when taken with the appended drawings in which:

FIG. 1 is a block diagram of the variable speed wind turbine in accordance with the present invention highlighting the key turbine elements, and illustrating vertical wind shear, which causes the over-turning moment;

FIG. 2 is a diagram illustrating rotating and fixed blade pitch position frames as seen from upwind for the rotor blades shown in FIG. 1.

FIG. 3 is a block diagram of a general feed-forward vertical wind shear compensator in parallel with a conventional collective controller;

FIG. 4 is a graph of an overturning moment M-table for shear exponent=−0.2 to +0.5 showing pitch=0 and pitch=5 deg limits for each alpha;

FIG. 5 is a graph of pitch motor RMS torque with vertical wind shear compensation and without vertical shear compensation using feed-forward control;

FIG. 6 is a graph of blade fatigue equivalent loading with vertical shear compensation and without vertical shear compensation using feed-forward control;

FIGS. 7A-C are graphs of equivalent shaft, nacelle, and tower loading with vertical shear compensation and without vertical shear compensation using feed-forward;

FIGS. 8A-H are graphs of over-turning moment M-table vs. wind speed, alpha and pitch plotted for different values of alpha;

FIGS. 9A-F are graphs of alpha vs. overturning moment, wind speed and pitch plotted for different values of pitch—the M′-table;

FIGS. 10A-F are graphs of pitch vs. overturning moment, wind speed and alpha plotted for different values of alpha—the M″-table;

FIG. 11 is a feed-forward controller block diagram;

FIG. 12 is a feedback PID based controller block diagram; and,

FIG. 13 is a feedback state space based controller block diagram.

### DETAILED DESCRIPTION OF THE INVENTION

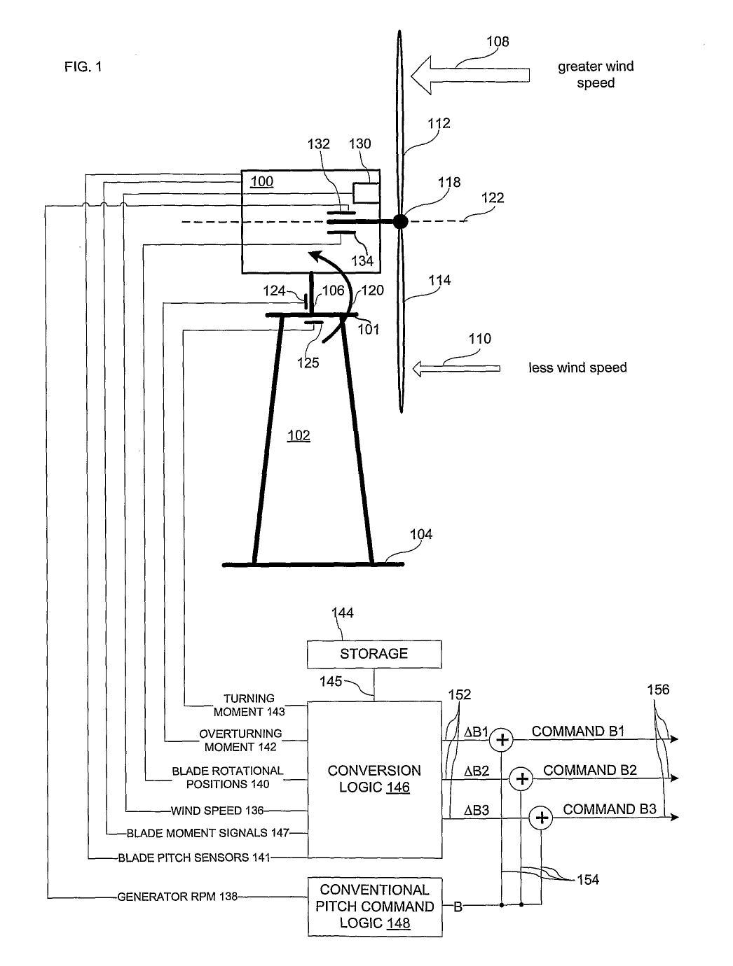

Refer to FIG. 1, which is a block diagram of a variable-speed wind turbine apparatus in accordance with the present invention. The wind power-generating device includes a turbine with one or more electric generators housed in a nacelle 100, which is mounted atop a tall tower structure 102 anchored to the ground 104. The nacelle 100 rests on a yaw platform 101 and is free to rotate in the horizontal plane about a yaw pivot 106 and is maintained in the path of prevailing wind current 108, 110.

The turbine has a rotor with variable pitch blades, 112, 114, attached to a rotor hub 118. The blades rotate in response to wind current, 108, 110. Each of the blades may have a blade base section and a blade extension section such that the rotor is variable in length to provide a variable diameter rotor. As described in U.S. Pat. No. 6,726,439, the rotor diameter may be controlled to fully extend the rotor at low flow velocity and to retract the rotor, as flow velocity increases such that the loads delivered by or exerted upon the rotor do not exceed set limits. The nacelle 100 is held on the tower structure in the path of the wind current such that the nacelle is held in place horizontally in approximate alignment with the wind current. The electric generator is driven by the turbine to produce electricity and is connected to power carrying cables inter-connecting to other units and/or to a power grid.

Vertical wind shear is the change in wind speed with height above ground, as illustrated in FIG. 1 by the greater wind speed arrow 108 and the lower wind speed arrow 110 closer to ground. Among other influences, vertical wind shear is caused by height-dependent friction with the ground surface 104. The higher the height above ground, 108, the less the affect of surface friction 104 and the higher the wind speed. The closer the height to ground, 110, the more the effect surface friction 104 has and the lower the wind speed.

The local vertical wind sheer can be estimated by use of a meteorological tower instrumented with more than one anemometer. The wind shear is estimated by curve fitting a power law to the wind speed vs. anemometer height. As the terrain varies, it is accordingly necessary to add additional towers.

The local horizontal wind shear can be estimated by use of several meteorological towers physically separated and sensitive to horizontal changes in wind and wind misalignment.

A more desirable approach, one that does not require additional scattered towers, is to use turbine information to estimate the effective wind shear. As wind shear does not appreciably alter the generator rpm or the motion of the tower, so a more direct measurement is needed.

Such a measurement is the nacelle over-turning moment illustrated by the arrow 120 in FIG. 1. The moment is measured about an axis perpendicular to vertical and to the direction of the driveline 122 of the wind turbine. Contributions to the value of this moment come from the overhanging mass of the rotor and nacelle, inertial accelerations of the rotor and nacelle, thrust forces on the rotor, and the vertical wind shear across the rotor that results in a net aerodynamic moment.

The over-turning moment 120 is the tendency of the nacelle 100 to over-turn due to the greater wind force 108 at the top of the blade disk and is measured using one or more force sensors 124 (such as strain gauges, instrumented bolts, etc.) at the point where the yaw pivot 106 attaches to the yaw platform 101. Being on an easily accessible part of the turbine, rather than on the blade or hub, the sensors 124 are easily serviced.

A similar measurement, for horizontal wind shear, is the turning moment sensed as the tendency of the turbine to yaw. A turning moment sensor 125 has an output 143, which is a turning moment signal.

An additional set of measurements is also used along with the turning and overturning measurements. These measurements are blade strain measured appropriately at a point or points along each blade to indicate the strain components in and out of the plane of the blade motion. Strain measurements are converted to equivalent moments.

The apparatus shown in FIG. 1 compensates for moment imbalance in a wind turbine 100. The pitch of the blades is controlled in a conventional manner by a command component, conventional pitch command logic 148, which uses generator RPM 138 to develop a nominal rotor blade pitch command signal 154. A storage 144 contains stored values of a set of turning, overturning, and blade measured moments for various wind speeds and pitch values. An overturning moment sensor 124 has an output, which is an overturning moment signal 142; a turning moment sensor 125 has an output 143, which is a turning moment signal; each blade has a blade-mounted strain sensor (not shown) has an output, which is converted to a blade moment signal 147. An instantaneous wind speed indicator 130 provides an output, which is an instantaneous wind speed value 136. Conversion logic 146 connected to the overturning moment signal 142, to the turning moment signal 143, to each blade moment signal 147, to the blade rotational positions 140, to the blade pitch sensors 141, and to the instantaneous wind speed value 136, provides an output, which is a calculated pitch modulation command 152. Combining logic 150 connected to the calculated blade pitch modulation command 152 and to the pitch command 154, provides a combined blade pitch command 156 capable of commanding pitch of the rotor blades, which includes compensation for instantaneous moment deviations of the wind turbine.

While wind conditions common to all blades are processed and taken into account by the conventional collective command logic 148, this logic may not detect, and certainly cannot respond to, conditions that may not appear in all blades simultaneously and that require individual blade control for mitigation. However, the pitch modulation command 152 takes into account these uncommon conditions. Since the commands 154 and 152 are combined into a command 156, the turbine control profits from the conventional collective control logic and the modulation of this signal accounting for non-collective conditions.

### DETAILED DESCRIPTION OF THE PREFERRED EMBODIMENT

Vertical wind shear is the change in wind speed with height above ground, as illustrated in FIG. 1. Among other influences, vertical wind shear is caused by height dependent friction with the ground surface. The higher the height above ground, the less the affect of surface friction and the higher the wind speed. A power law function is generally used to model this phenomenon as

windSpeed∝h^{α}

where h is height above ground and α is a power exponent typically 0.14. The actual power exponent varies with local wind conditions and with the type of terrain.

As vertical wind shear causes the wind speed to vary with height, a turbine blade sees varying wind speed as it rotates about the turbine hub. The cyclic wind speed variation imparts a cyclic varying force on the blades causing the blades to flex back and forth leading to fatigue failure. From the equation above, the wind speed at an elevation h is related to the hub height h_{hub} and the wind speed at the hub windSpeed_{hub} as

$$windSpeed ( h ) = {{windSpeed}_{hub} ( \frac{h}{{h}_{hub}} )}^{α}$$

At a point on a blade a distance r from the hub, as the blade rotates about the hub with rotational angle φ measured from vertical, the wind speed is cyclic:

$$\begin{matrix}windSpeed ( ϕ ) = {{windSpeed}_{hub} ( \frac{{h}_{hub} + r cos ϕ}{{h}_{hub}} )}^{α} \\ = {{windSpeed}_{hub} ( 1 + \frac{r}{{h}_{hub}} cos ϕ )}^{α}\end{matrix}$$

The cyclic force acting on the blade at r is a function of the wind speed squared and of the aerodynamic thrust coefficient C_{T} defined by the wind speed, the blade rotation rate and the pitch angle β:

$$windForce ( ϕ ) ∝ {windSpeed}^{2} {C}_{T} ( windSpeed , \dot{ϕ} , β ) ∝ {{windSpeed}_{hub}^{2} ( 1 + \frac{r}{{h}_{hub}} cos ϕ )}^{2 α} {C}_{T} ( windSpeed , \dot{ϕ} , β )$$

This suggests the cyclic wind force can be made more uniform by varying the pitch angle as a function of rotation angle: toward feather for a blade position zero and away from feather at blade position 180°. The resulting cyclic modulation of the blade pitch is different for each blade since each has a different rotation angle.

Horizontal wind shear is not amenable to models but must be measured in the field, typically approximated as a linear variation.

Conversion From Rotating to Fixed and Fixed to Rotating Reference Frames:

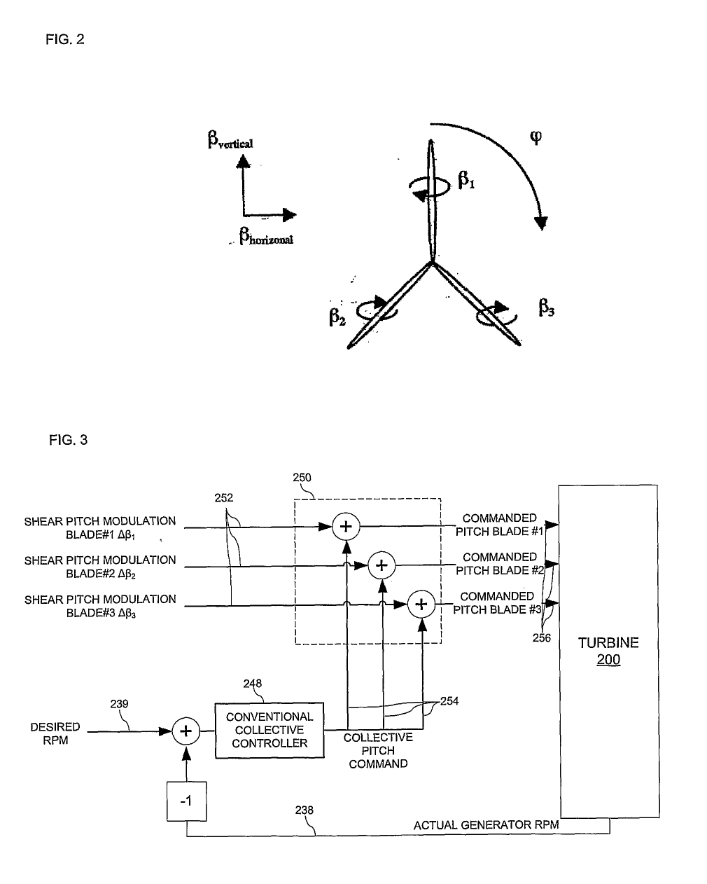

As used below, it is helpful to translate the blade pitch angles from the rotating frame (rotation about the hub) to a non-rotating frame. This is simply done using the Coleman multi-blade transformation (also known as d-q transform for rotating electrical equipment). If (β₁, β₂, β₃) are the three blade pitch angles and (φ₁, φ₂, φ₃) are the blade rotational positions around the hub as illustrated in FIG. 2. the vertical and horizontal components are determined as

$$[ \begin{matrix}{β}_{vertical} \\ {β}_{horizonal}\end{matrix} ] = \frac{2}{3} [ \begin{matrix}cos {ϕ}_{1} & cos {ϕ}_{2} & cos {ϕ}_{3} \\ sin {ϕ}_{1} & sin {ϕ}_{2} & sin {ϕ}_{3}\end{matrix} ] ⌊ \begin{matrix}{β}_{1} \\ {β}_{2} \\ {β}_{3}\end{matrix} ⌋$$

The inverse transformation is

$$⌊ \begin{matrix}{β}_{1} \\ {β}_{2} \\ {β}_{3}\end{matrix} ⌋ = ⌊ \begin{matrix}cos {ϕ}_{1} & sin {ϕ}_{1} \\ cos {ϕ}_{2} & sin {ϕ}_{2} \\ cos {ϕ}_{3} & sin {ϕ}_{3}\end{matrix} ⌋ [ \begin{matrix}{β}_{vertical} \\ {β}_{horizonal}\end{matrix} ]$$

These coordinate transformations are also used to convert the rotating blade moments into vertical and horizontal components.

Feed-Forward Control

Refer to FIG. 3, which is a block diagram of a general feed-forward vertical wind shear compensator in parallel with a conventional collective controller. The apparatus shown in FIG. 3 compensates for moment imbalance in a wind turbine 200. The pitch of the blades is controlled in a conventional manner by a command component, conventional collective controller 248, which uses actual generator RPM 238 fed back to and combined with a desired RPM 239 to develop a collective pitch command signal 254. Conversion logic (not shown) connected to an overturning moment signal, to a turning moment signal, to each blade moment signal, to the blade rotational positions, to the blade pitch sensors, and to the instantaneous wind speed value, provides an output for each of the blades #1, #2 and #3, which is a calculated pitch modulation command 252. Combining logic 250 connected to the calculated shear blade pitch modulation command 252 and to the collective pitch command 254, provides a combined blade pitch command 256 capable of commanding pitch of the rotor blades, which includes compensation for instantaneous moment deviations of the wind turbine 200.

The collective controller 248 therefore provides a control signal used as basis for controlling each of the blades #1, #2 and #3. However, the combining logic 250 outputs individual blade commands by modulating the collective command signal 254 by individual blade pitch modulation command 252.

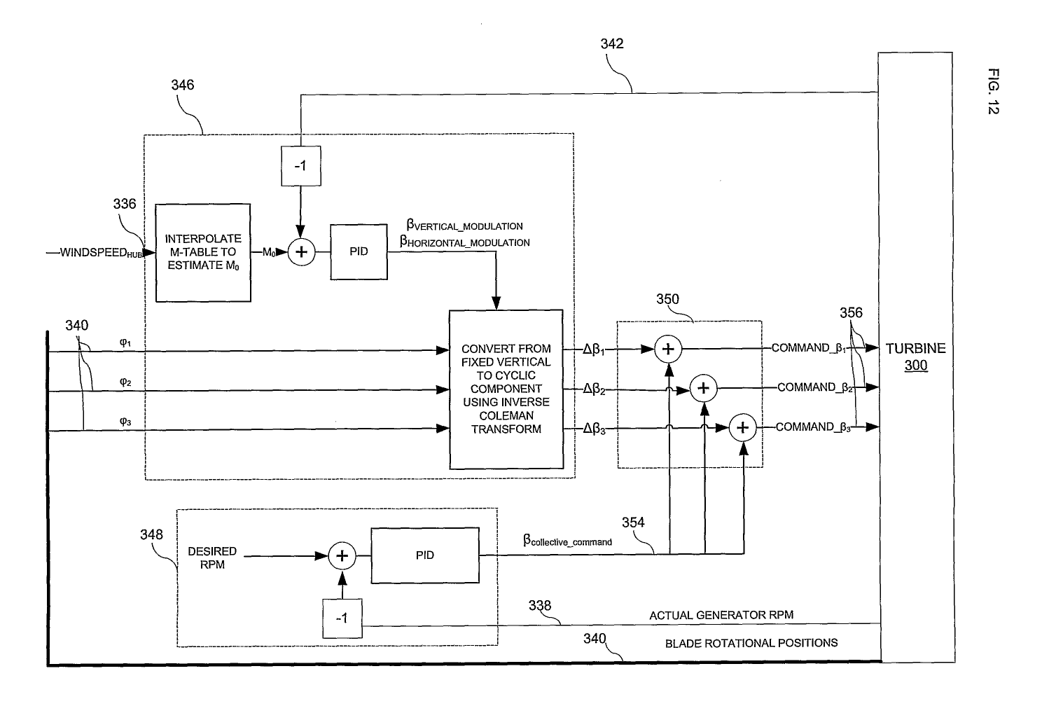

Refer to FIG. 11, which is a block diagram of a more detailed feed-forward vertical wind shear compensator in parallel with a conventional collective controller. The apparatus shown in FIG. 11 compensates for moment imbalance in a wind turbine 400. The pitch of the blades is controlled in a conventional manner by a command component, conventional collective controller 448, which uses actual generator RPM 438 fed back to and combined with a desired RPM 439 to develop a collective pitch command signal 454.

Conversion logic 406 converts from cyclic to fixed components using the Coleman transform resulting in a vertical component 409 and a horizontal component 413 which are inputted to logic 408.

Logic 408 connected to an overturning moment signal, to a turning moment signal, to each blade moment signal, to the blade rotational positions, to the blade pitch sensors, and to the instantaneous wind speed value 403, provides an output which is a modulation 415 in vertical component 409 and horizontal component 413.

The modulation 415 in vertical component 409 and a horizontal component 413 and blade rotational positions 404 are inputted to conversion logic 407, which converts from fixed to cyclic component using the inverse Coleman transform to develop a blade pitch modulation command 411.

Combining logic 412 connected to the calculated blade pitch modulation command 411 and to the collective pitch command 454, provides a combined blade pitch command 422 capable of commanding pitch of the rotor blades, which includes compensation for instantaneous moment deviations of the wind turbine 400.

A feed-forward control scheme, such as the one shown in FIG. 3 and in more detail in FIG. 11, is relatively simple to implement in that it operates in parallel with existing conventional controls. Assuming the pitch modulation Δβ_{blade} for each blade is known, the feed-forward approach to compensate for wind shear is to modulate the pitch commanded by the conventional controller in a feed-forward control scheme as shown in FIG. 3 and FIG. 11.

The net pitch command sent to the blade pitch motors is

pitch_{blade}=pitch_{collective}+Δβ_{blade}

where pitch_{collective} is the nominal pitch command generated by the controller.

The conventional collective controller is a PID or state space or any other type of control system. A three-bladed turbine is illustrated, however any number blades may be used. A collective controller with pitch as its only output is illustrated, however generator torque and any other output is possible. A collective controller with generator rpm as its only input is illustrated, however, actual blade pitch and any other inputs are within the scope of this invention.

Calculating the Pitch Modulation for Feed-Forward:

One approach to estimate the local vertical wind sheer shear power exponent α is to use a meteorological tower instrumented with more than one anemometer. The exponent is evaluated by curve fitting the power law to the wind speed vs. anemometer height. As the terrain varies, it is accordingly necessary to add additional towers.

The preferred feed-forward approach, one that does not require additional scattered towers, is to use turbine information to estimate the effective wind shear as well as the desired pitch modulation. Wind shear does not appreciably alter the generator rpm nor the motion of the tower, and more direct measurement is needed to estimate the effective vertical wind shear power exponent as well as the desired pitch modulation.

The preferred measurement of over-turning moment illustrated in FIG. 1. The moment is measured about an axis mutually perpendicular to the vertical and to the direction of the driveline of the wind turbine. Contributions to the value of this moment come from the overhanging mass of the rotor and nacelle, inertial accelerations of same, thrust forces on the rotor, and the vertical wind shear across the rotor that results in a net aerodynamic moment. The overturning moment is the tendency of the nacelle to over-turn due to the greater wind force at the top of the blade disk and is simply measured using one or more force sensors (such as strain gauges, instrumented bolts, etc.) at the point where the yaw pivot attaches to the yaw platform. Being on an easily accessible part of the turbine, rather than on the blade or hub, the sensors are easily serviced.

The preferred measurement of turning moment is measured about the yaw axis. Contributions to the value of this moment come from the yaw errors and horizontal wind shear. The turning moment is the tendency of the nacelle to turn due to the greater wind force on one side of the blade disk and is simply measured using one or more force sensors (such as strain gauges, instrumented bolts, etc.) at the point where the yaw pivot attaches to the yaw platform. Being on an easily accessible part of the turbine, rather than on the blade or hub, the sensors are easily serviced.

The preferred measurement of blade in-plane and out-of-plane moments are strain sensors measuring the direct effect of wind shear on the blade bending. Insensys, Ltd. at 6 & 7 Compass Point Ensign Way, Hamble, Southampton, United Kingdom SO31 4RA, designs and supplies sensing systems using fiber optic technology for measuring strain within composite structures. A small, lightweight system uses 0.25 mm diameter optical fibers embedded within the composite manufacturing process to provide real-time load measurements, such as measuring the direct effect of wind shear on the blade bending. Although not easily serviced, they have no moving parts and are considered rugged. These measurements are compensated for blade pitch and converted to in-plane and out-of-plane moments.

Turbine simulation studies provide the dependence of turning moment, over-turning moment, and blade in- and out-of-plane moments to other parameters: hub wind speed and the vertical and horizontal components of the pitch modulation magnitude Δβ_{vertical} and Δβ_{horizontal}. Each dependency is tabulated by simulating the turbine at various steady state conditions while changing the dependent parameters. This yields a table or tables representing the turning, overturning, and blade moments as a function of the Δβ_{vertical}, Δβ_{horizontal}, wind-speed_{hub}. An algorithm to calculate the required pitch modulation for each blade uses the moment tables.

Wind Speed Determination for Feed-Forward:

Wind speed is determined by anemometer measurement at hub height. An alternative is to use a wind speed estimator such as in copending U.S. patent application Ser. No. 11/128,030 titled “Wind flow estimation and tracking using tower dynamics”, US Publication Number 2006-0033338 A1, published Feb. 16, 2006.

Feed-Forward Vertical Wind Shear Simulation Studies:

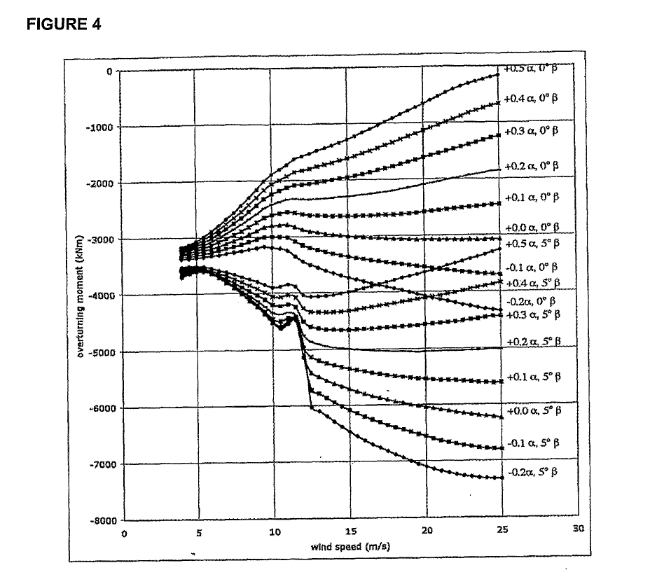

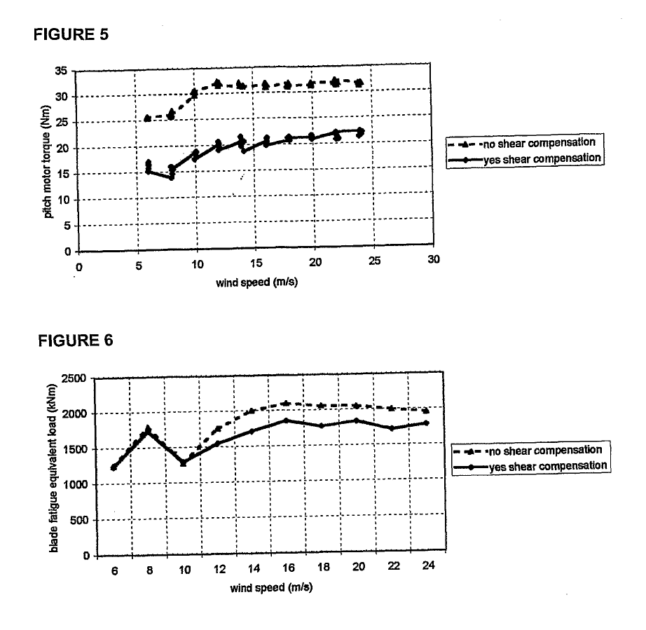

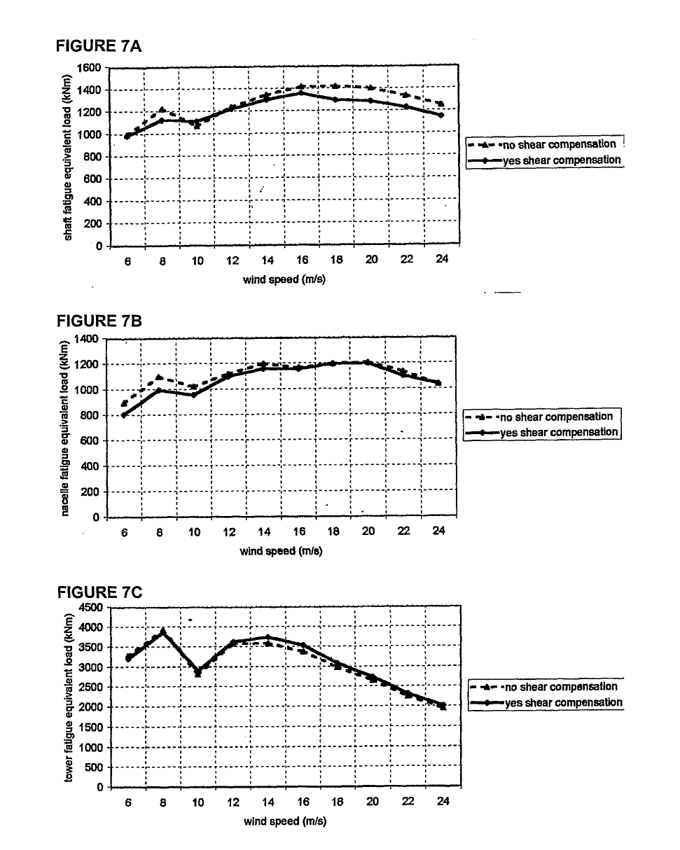

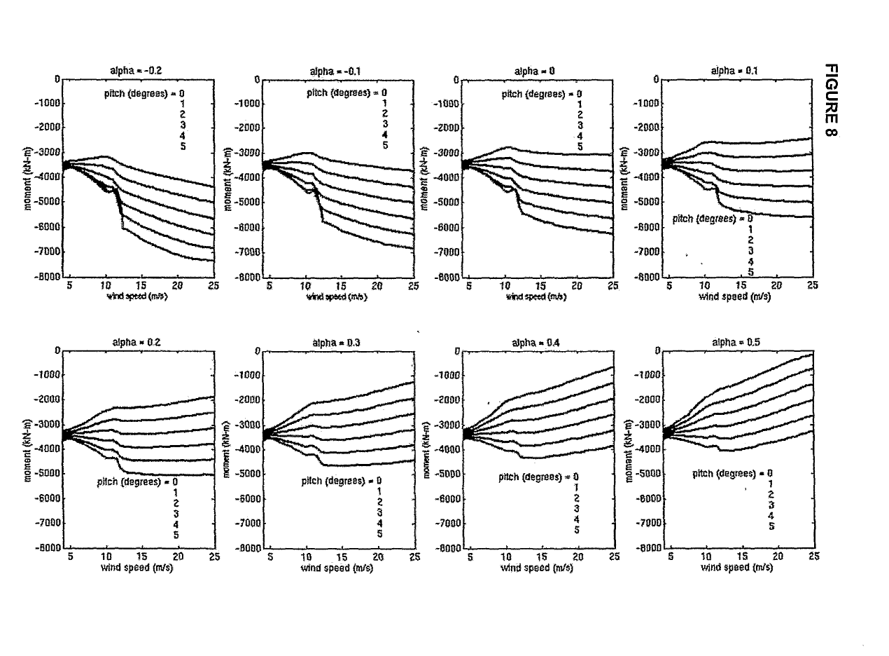

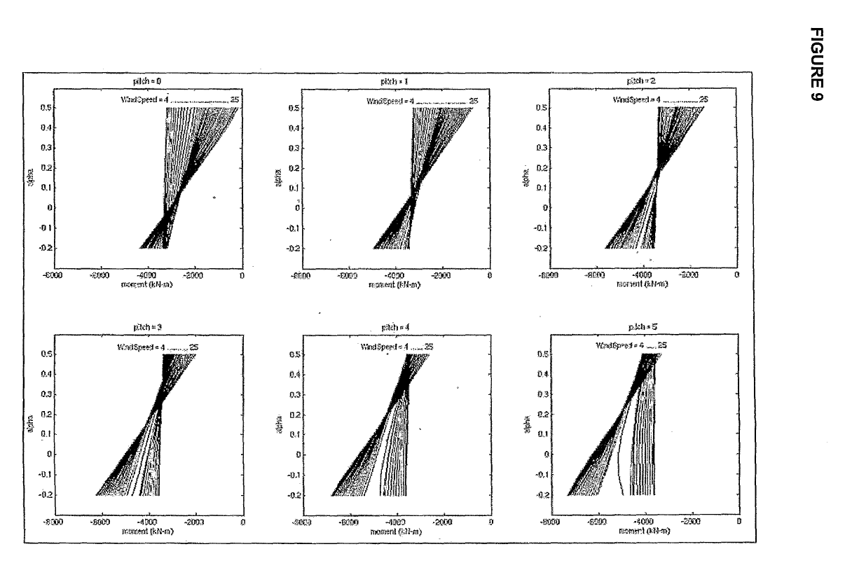

To generate load comparisons, ADAMS simulation studies were performed of a 2.5 Megawatt turbine having an 80-m hub height, three full chord 46-m blades, and a conventional collective PI controller. Simulation runs were performed to produce the relationships shown in FIGS. 4 and 8; vertical wind shear compensation system of FIGS. 3 and 11 was developed; and the turbine with the compensation was simulated in turbulent air with and without the vertical shear compensator. The results of the simulation were submitted to standard load evaluation with results shown in FIG. 6 and FIG. 7, and the pitch motor torque in FIG. 5. Substantial improvement is seen in the pitch motor torque and blade equivalent loads.

The over 10% reduction in blade loading at wind speeds greater the 10 m/s is substantial. The 33% reduction in pitch motor torque is also substantial. This is due to the correlation between the pitch demand and the gravity forces that act as a load on the pitch motor. The blades are typically pitched to their furthest feather position when they are vertically up (rotor position=0 degrees). As the blade moves down to 90 degrees and a horizontal position the vertical cyclic pitch is back towards stall. The gravity forces on the blade at 90 degrees are eccentric to the pitch axis and create a pitch moment that aids this motion towards stall. At 270 degrees the blade pitches back towards feather with the aid of gravity also. So not only does gravity assist with the pitch action required for shear compensation, but it allows the motor to exert less effort on the collective pitch control as it does not have to hold against gravity.

The reduction in blade pitch torque is specific to blades with pre-bend or pre-curve, i.e. where the center of gravity is eccentric to the pitch axis. Blade pre-bend or pre-curve is what causes the center of gravity to be eccentric to the pitch axis. Pre-bend and pre-curve have only recently been put into the larger blades to move the tips farther out from the tower. It is conceivable that new materials or designs might mitigate the need for this solution, or that the coning effect would be included in the hub thus realigning the pitch axis with the blade, etc. Then if the blade center of gravity is on the pitch axis then there is no load on the motor from gravity trying to twist the pitch and hence no benefit arises from the cyclic pitch.

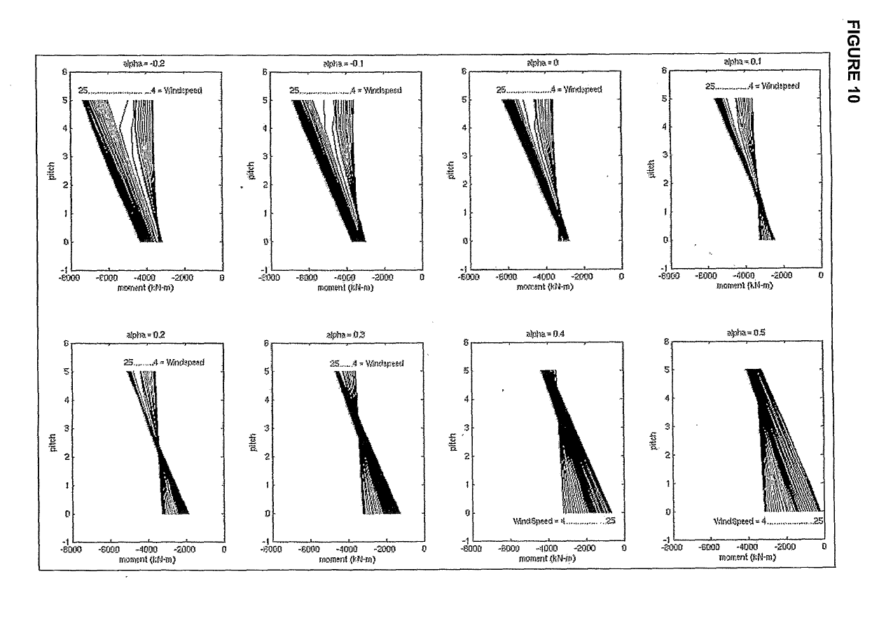

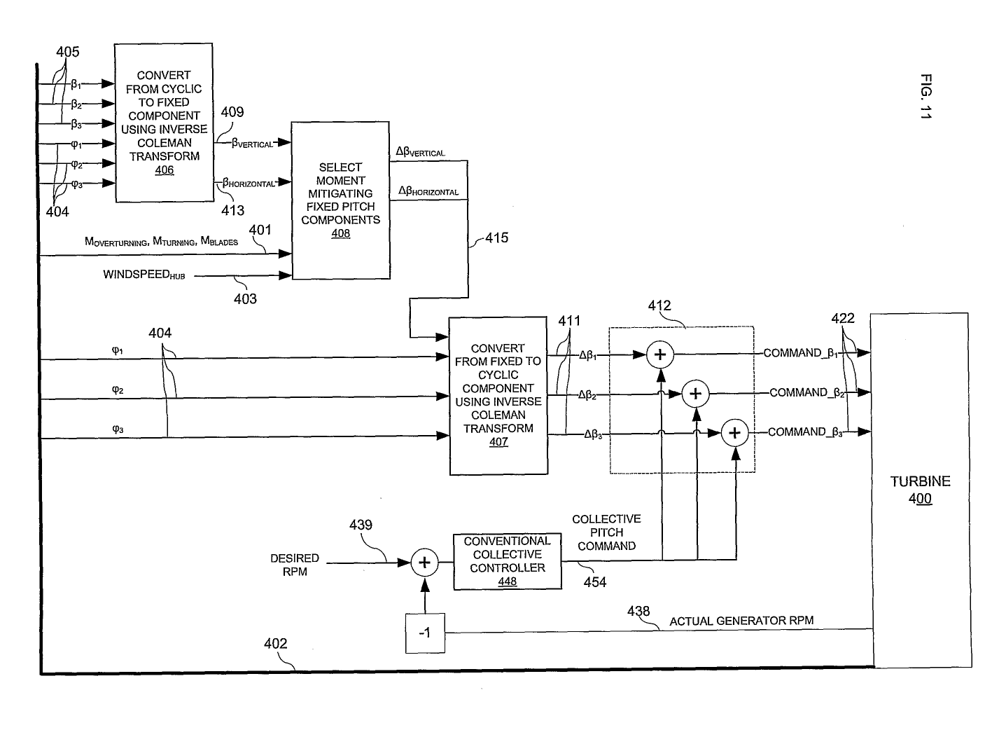

There are several circumstances where the shear compensation does not offer improvement and should not be used. As seen in FIG. 9 and FIG. 10, at low wind speeds the relationship between both pitch and α and the other table parameters are vertical line meaning pitch and a are not reliably estimated in these conditions. The result, reflected in FIGS. 5 through FIG. 7 is poor performance at wind speeds below 10 m/s.

Under unusual wind conditions it is possible to have a negative α where the wind speed vertical shear is reversed. The blade loading remains improved, but the pitch motor torque is increased. Torque increases as the blades are working against gravity, instead of with it.

Feedback Control

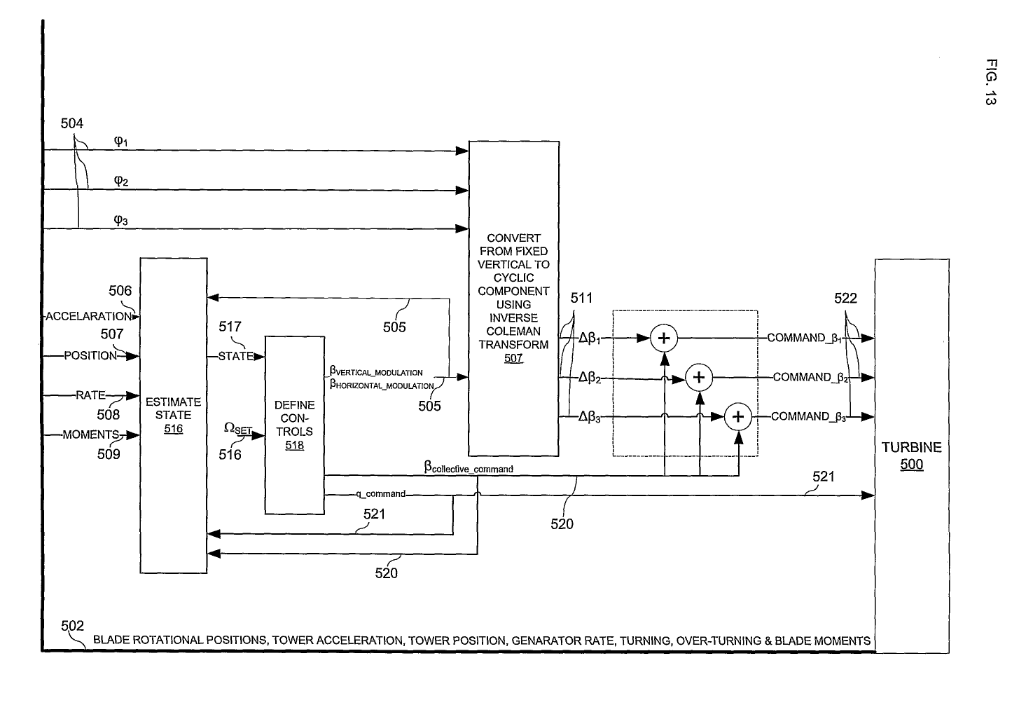

Feedback control is often preferable to feed-forward. FIG. 12 is a block diagram of a feedback PID based controller apparatus in accordance with the present invention. The apparatus shown in FIG. 12 compensates for moment imbalance in a wind turbine 300. The nominal pitch of the blades is controlled in a conventional manner by a command component 348, which uses actual generator RPM 338 to develop a rotor blade pitch command signal 354.

The modulation 345 of the pitch of the blades is controlled by moment compensation logic component 346. Conversion logic 346 is connected to the blade rotational positions 340, to the blade pitch sensors 341, to the instantaneous wind speed value 336, to the turning over-turning and blade moments 342 and provides an output 345, which is a calculated pitch modulation command. Combining logic 350 connected to the calculated blade pitch modulation command and to the collective pitch command 354, provides a combined blade pitch command 356 capable of commanding pitch of the rotor blades, which includes compensation for instantaneous moment deviations of the wind turbine.

FIG. 13 is a feedback state space based controller block diagram. The apparatus shown in FIG. 13 compensates for moment imbalance in a wind turbine 500. Sensors in the turbine and tower generate signals on the bus 502, which include blade rotational positions 504, tower acceleration 506, tower position 508, generator rate 510, turning, over-turning and blade moments 509.

The estimated state logic 516 uses the sensor outputs from the turbine 500, which include tower acceleration 506, tower position 507, generator rate 508 and over-turning moment 509, to estimate the state 517.

The define controls logic 518 uses the RPM set input 516 and the state 517 to develop the modulation (vertical and horizontal) command 505, the collective pitch command 520 and the torque command 521.

The blade rotational positions 504 and vertical command 505 are inputted to conversion logic 507, which converts from fixed to cyclic component using the inverse Coleman transform to develop a blade pitch modulation command 511.

Combining logic 512 connected to the calculated blade pitch modulation command 511 and to the collective pitch command 520, provides a combined blade pitch command 522 to the turbine 500, which is capable of commanding pitch of the rotor blades. The command 522 includes compensation for instantaneous moment deviations of the wind turbine.

While the invention has been particularly shown and described with reference to preferred embodiments thereof, it will be understood by those skilled in the art that the foregoing and other changes in form and detail may be made therein without departing from the scope of the invention.

1-7. (canceled)

8. An apparatus that compensates for moment imbalance in a wind turbine, the turbine having a rotor with at least two variable pitch blades, the apparatus comprising:
a conventional pitch command logic, developing a nominal rotor blade pitch command signal;
a moment sensor, being one or more of a nacelle over-turning moment sensor and a turning moment sensor, an output of which is a moment signal;
conversion logic connected to said moment signal, an output of said conversion logic being calculated individual pitch modulation commands for each of the blades; and,
combining logic connected to receive said calculated individual blade pitch modulation commands and to receive said nominal pitch command, an output of said combining logic being individual combined blade pitch commands for each of the blades, the individual combined blade pitch commands being generated by modulating the nominal command signal by a respective blade pitch modulation command which includes compensation for instantaneous moment deviations of said wind turbine.

9. The apparatus of claim 8, further including at least one blade strain sensor, an output of which being a strain component signal, the conversion logic being connected to receive said strain component signal of said at least one blade strain sensor.

10. The apparatus of claim 8, wherein said conversion logic calculates multiple individual blade pitch modulation commands, one command assigned to each of the blades.

11. The apparatus of claim 9, wherein said conversion logic calculates multiple individual blade pitch modulation commands, one command assigned to each of the blades.

12. The apparatus of claim 8 wherein a storage stores pre-calculated values, each of said pre-calculated values being assigned to and referenced by one or more sets of signals received by the combining logic.

13. The apparatus of claim 12, wherein said conversion logic calculates multiple individual blade pitch modulation commands, one command assigned to each of the blades.

14. The apparatus of claim 8 wherein the source of said moment imbalance is one or more of vertical wind shear, horizontal wind shear, blade moment and wind misalignment.

15. A method of moment imbalance compensation in a wind turbine, which uses a nominal pitch command to control a pitch of at least two rotor blades of said wind turbine, comprising steps of:
A. storing a relationship between various values of instantaneous moment and a pitch modulation that compensates for deviations of the instantaneous moment from a nominal moment value;
B. sensing an instantaneous moment of said wind turbine resulting in a moment signal;
C. using said moment signal to fetch a stored instantaneous moment value;
D. calculating an individual blade pitch modulation for each rotor blade to compensate for said instantaneous moment imbalance using said instantaneous moment value;
E. combining said calculated individual blade pitch modulations with said pitch command resulting in individual combined pitch commands for each of the rotor blades; and
F. using said individual combined pitch commands to control pitch of each of the rotor blades in order to compensate for said instantaneous moment deviations of said wind turbine.

16. The method of claim 15 wherein the source of said moment imbalance is one or more of vertical wind shear, horizontal wind shear, blade moment and wind misalignment.
